(19) United States
(12) Patent Application Publication
(10) Pub. No.: US 2013/0269203 A1
(43) Pub. Date: Oct. 17, 2013

(54) KIT FOR A DRYER PORTION OF A DRYER AND METHOD FOR PRODUCING A DRYER PORTION OF A DRYER

(71) Applicant: Dürr Systems GmbH, Bietigheim-Bissingen (DE)

(72) Inventors: Peter Näpfel, Tamm (DE); Klaus-Eugen Herbst, Steinfurt (DE); Konrad Ortlieb, Stuttgart (DE); Jürgen Weschke, Well der Stadt (DE)

(21) Appl. No.: 13/909,342

(22) Filed: Jun. 4, 2013

Related U.S. Application Data
(63) Continuation of application No. PCT/EP2011/072800, filed on Dec. 14, 2011.

(30) Foreign Application Priority Data
Dec. 16, 2010 (DE) 102010063260.0

(51) Int. Cl. F26B 25/12

(52) U.S. Cl. CPC F26B 25/12
USPC 34/201; 29/890.03

(57) ABSTRACT

A kit for a dryer portion of a dryer is provided, by means of which a dryer portion of the dryer can be transported in a particularly space-saving manner to an assembly site of the dryer and can be assembled from particularly few parts, wherein the kit comprises at least two components, at least one left-hand side wall component comprising a left-hand side wall portion of the dryer, at least one right-hand side wall component comprising a right-hand side wall portion of the dryer and at least one component comprising a base wall portion and/or a ceiling wall portion of the dryer and a conveying unit of a conveying device for conveying workpieces to be dried through the dryer in the assembled state of the dryer, the dryer portion of the dryer being configured to be assembled at an assembly site from the at least two components of the kit.

### CROSS-REFERENCE TO RELATED APPLICATIONS

The present application is a continuation of international application number PCT/EP2011/072800, filed on Dec. 14, 2011, which claims priority to German patent application number 10 2010 063 260.0, filed Dec. 16, 2010, the entire specification of both being incorporated herein by reference.

### FIELD OF DISCLOSURE

The present invention relates to a kit for a dryer portion of a dryer.

### BACKGROUND

Dryers are used, for example, for drying and curing surface-treated workpieces, in particular painted vehicle bodies or parts of vehicle bodies. For this purpose, the workpieces are moved through the dryer, for example within a usable dryer space of the dryer. In particular when large workpieces, for example vehicle bodies, are to be dried, the dryer itself has to be very large. In such cases, it is not possible to produce the dryer at a production and assembly site and transport it to a site of use that is different from this in the assembled state. Rather, the dryer has to be brought to the site of use in individual parts and assembled there. In such cases, the site of use is consequently the site of assembly of the dryer.

### SUMMARY OF THE INVENTION

The present invention is based on the object of providing a kit for a dryer portion of a dryer, which allows a dryer to be produced from a small number of component parts at the assembly site of the dryer and easy transportation of the kit from the production site of the kit to the assembly site of the dryer.

This object is achieved according to the invention in a kit for a dryer portion of a dryer in that the kit comprises at least two components, at least one left-hand side wall component comprising a left-hand side wall portion of the dryer, at least one right-hand side wall component, comprising a right-hand side wall portion of the dryer and at least one component comprising a base wall portion and/or a ceiling wall portion of the dryer and a conveying unit of a conveying device to convey workpieces to be dried through the dryer in the assembled state of the dryer, the dryer portion of the dryer being configured to be assembled at the assembly site from the at least two components of the kit.

A dryer for vehicle bodies or for parts of vehicle bodies can, in particular, be produced by means of the kit according to the invention.

The kit preferably comprises only a few, at most four, components for a dryer portion. The number of component parts for a dryer portion of the dryer is therefore particularly small.

The prefabricated components of the kit may basically be identical to one another or different from one another.

A component, which comprises a base wall portion, is designated as a base wall component.

A component, which comprises a ceiling wall portion, is designated as a ceiling wall component.

In the kit according to the invention, at least two, in each case, of the components of the kit are preferably identical to one another. The kit then, for example, has at least one component, which comprises both a side wall portion (right-hand or left-hand side wall component) and a base wall portion and/or a ceiling wall portion (base wall component and/or ceiling wall component). As a result, assembly of the dryer portion of the dryer at the assembly site of the dryer is additionally facilitated.

The left-hand side wall component can thus be identical, in particular, to the base wall component and/or the ceiling wall component. Likewise, the right-hand side wall component can be identical to the base wall component and/or to the ceiling wall component.

It may be advantageous if at least one component is prefabricated. A “prefabricated component” according to the present description and the accompanying claims is a functional unit which is individually completed and only has to be connected to other components to form the dryer portion of the dryer. To produce the dryer portion of the dryer at the assembly site, only connecting elements are therefore necessary, by means of which the components of the kit can be connected to one another. However, in the case of prefabricated components, no further functional elements preferably have to be attached to the components of the kit in order to completely assemble the dryer portion of the dryer.

Prefabricated components may, for example, be parts of a dryer manufactured from a plurality of component parts connected to one another in an integral manner. However, they may also be components (part systems of a dryer), which have been releasably connected to one another mechanically (in particular screwed) or non-releasably connected mechanically (in particular riveted) in one (or more) earlier processing step(s). As a further alternative, components formed in a plurality of steps (in particular rolled, folded, cast) and substantially configured in one part, can also be provided, the different portions of which adopt different functions (ceiling, side wall, base wall) in the dryer.

It may be advantageous if electric, pneumatic or hydraulic systems are integrated in a prefabricated component and allow a functional test of movable component parts of the component before transportation to the assembly site.

It may furthermore be advantageous if at least one conveying unit of the conveying device is preassembled on the at least one component. A “preassembled conveying unit” is to be taken to mean, in this description and the accompanying claims, a conveying unit, in which all the component parts to be rigidly arranged are already connected to one another, in particular are integrated in the base wall portion and/or the ceiling wall portion of the dryer. To make the dryer operational, substantially only loose parts, such as, for example, carrying rollers in preassembled carrying roller receivers or a shaft to drive the carrying rollers preferably still have to be assembled.

The dryer is preferably assembled from a plurality of dryer portions following one another in a longitudinal direction of the dryer. The longitudinal direction of the dryer is, in particular, a conveying direction of the conveying device.

The dryer portions are also called “dryer modules” of the dryer.

In one configuration of the invention it is provided that the base wall portion comprises at least one air feed, by means of which, in an assembled state of the dryer, air is feedable to a usable dryer space of the dryer. In this manner, air can be fed from below, for example, to a vehicle body conveyed through the usable dryer space, in order to accelerate the drying and/or curing of the workpiece, in other words the vehicle body, in a lower portion of the workpiece.

It is favorable if at least one component, which comprises a side wall portion, comprises at least one air feed, by means of which, in an assembled state of the dryer, air is feedable to a usable dryer space of the dryer. In this manner, air can be applied, in particular, to one side of a workpiece conveyed through the usable dryer space to dry said workpiece.

It may be advantageous if at least one component, which comprises a side wall portion, comprises at least one supply channel, which is used to supply at least one air feed of a side wall portion and/or at least one air feed of a base wall portion with air. No additional external supply channels outside the dryer portion of the dryer are thus necessary to supply the air feeds with air. Rather the supply of the air feeds with air takes place through a supply channel integrated into the dryer portion of the dryer.

In one configuration of the invention it is provided that at least one component of the kit, which is preferably a prefabricated component, comprises a side wall portion and a base wall portion. An assembly of the side wall portion on the base wall portion at the assembly site of the dryer portion of the dryer can thus be facilitated.

It may, for example, be provided that the at least one right-hand side wall component comprises a right-hand side wall portion and a base wall portion or the at least one left-hand side wall component comprises a left-hand side wall portion and a base wall portion.

It may be favorable if the side wall portion and the base wall portion, preferably in the prefabricated state of the at least one component comprising the side wall portion and the base wall portion, are pivotably connected to one another. As a result, the at least one component can be transported in a space-saving manner from the production site of the component to the assembly site of the dryer portion of the dryer.

In a development of the invention it is provided that at least one component of the kit comprises a ceiling wall portion of the dryer.

In particular, it may be provided here that at least one component of the kit comprises a side wall portion and a ceiling wall portion.

For example, the at least one right-hand side wall component of the kit comprises a right-hand side wall portion and a ceiling wall portion or the at least one left-hand side wall component comprises a left-hand side wall portion and a ceiling wall portion.

It may be favorable if the side wall portion and the ceiling wall portion, preferably in the prefabricated state of the at least one component, are pivotably connected to one another. A compact transportation of the at least one component from its production site to the assembly site of the dryer portion of the dryer is thus possible.

In one configuration of the invention it may be provided that at least one component comprises a base wall portion, which extends, in an assembled state of the dryer, at least over the entire width of a usable dryer space of the dryer. In this manner, the base wall portion at the time of the production of the at least one component, can already be made continuous, in other words extending over the entire width of the usable dryer space of the dryer, so no additional connections between various base wall portions have to be produced for the assembly of the dryer portion of the dryer in the region of the base of the usable dryer space in a horizontal direction and perpendicular to the conveying direction of the conveying device.

The usable dryer space is that space here, in which, in the assembled state of the dryer, the workpieces to be dried can be dried, preferably while the workpieces are conveyed through the usable dryer space.

The width of the usable dryer space is, in this case, the horizontal extent of the usable dryer space in the direction perpendicular to the conveying direction of the conveying device.

The base wall portion of the at least one component in a further configuration of the invention may, however, also extend further than only over the entire width of the usable dryer space of the dryer in the assembled state of the dryer. Thus, it may be provided, for example, that the base wall portion of the at least one component extends over the width of the usable dryer space of the dryer and additionally over the width of at least one side wall portion of the dryer portion of the dryer.

Furthermore, it may be provided that at least one component comprises a base wall portion, which, in an assembled state of the dryer, extends at least approximately over the entire width of the dryer in the assembled state of the dryer.

The width of the dryer is, in this case, the horizontal extent of the dryer in the assembled state in the direction perpendicular to the conveying direction of the conveying device.

In one configuration of the invention it is provided that the conveying unit of the conveying device comprises a plurality of carrying roller units following one another in a conveying direction of the conveying device to convey workpieces to be dried through the dryer, said carrying roller units in each case having at least one carrying roller receiver to receive a carrying roller, on which workpiece carriers, on which the workpieces to be dried are configured to be arranged, are placeable in the assembled state of the dryer. As a result, a particularly simple configuration of a conveying unit is possible, which allows a compact base wall portion to be produced.

The workpiece carriers may, for example, be configured as skid frames. A “skid frame” is, in this case, to be taken to mean a workpiece carrier, which comprises at least two skid runners, which are oriented along the same direction of the workpieces and are spaced apart from one another transverse to the conveying direction of the workpieces, each skid runner having a support face for supporting the skid frame on the conveying device, in particular on the carrying roller units of the conveying units.

The kit preferably comprises a drive device for driving the conveying device. The workpieces can thus be automatically conveyed through the dryer in the assembled state of the dryer.

The drive device may, for example, be configured as a drive shaft. The drive device preferably additionally comprises a motor.

It may be advantageous if the drive device is arranged at least partially outside the dryer base.

As an alternative to this, however, it may also be provided that the at least one component of the kit for the dryer portion of the dryer, for example that which comprises the base portion, comprises a receiver for the drive device.

It may be advantageous if the drive device for driving the conveying device is arranged on a side wall portion and/or on the base wall portion.

In particular, it may be provided that the drive device is configured to be arranged in a receiver in the base wall portion.

In one configuration of the invention it is provided that at least one component comprises a side wall portion, which extends at least over the entire height of a usable dryer space of the dryer in an assembled state of the dryer. A two-part configuration of the side wall portion is thus avoidable, so the assembly of the dryer portion of the dryer at the assembly site is thus facilitated.

The height of the usable dryer space, in this description and the accompanying claims, is to be taken to mean the vertical extent of the usable dryer space in the direction perpendicular to the conveying direction of the conveying device in the completely assembled state of the dryer.

In a preferred configuration of the invention it is provided that at least one component comprises a side wall portion, which, in an assembled state of the dryer, extends at least approximately over the entire height of the dryer.

The height of the dryer is, in this case, the vertical extent of the dryer in the assembled state in the direction perpendicular to the conveying direction of the conveying device.

The kit according to the invention is suitable, in particular, for use in a combination of a kit and a receiving device for receiving the at least two components of the kit during transportation of the kit from at least one production site of the at least two components to the assembly site of the dryer.

A particularly easy and convenient provision of the component parts for a dryer portion of the dryer at the assembly site of the dryer is possible by means of the combination according to the invention.

The combination according to the invention of a kit and a receiving device preferably has the features and/or advantages described above in conjunction with the kit according to the invention.

The present invention also relates to a dryer, which is producible using at least one kit according to the invention. In particular, this may be a dryer, which is produced using at least one kit according to the invention.

The dryer according to the invention preferably has the features and/or advantages described above in conjunction with the kit according to the invention and/or the combination according to the invention.

In an advantageous configuration of the dryer it is provided that the dryer comprises a plurality of base wall portions, which are arranged following one another in a conveying direction of the conveying device and comprise, in each case, at least one air feed, the base wall portions having a fluid connection alternately to at least one supply channel in at least one right-hand side wall portion and to at least one supply channel in at least one left-hand side wall portion to supply the air feed with air. In this manner, a uniform air feed to the base wall portion and therefore to the at least one air feed in the base wall portion is possible.

The present invention furthermore relates to a method for producing a dryer portion of a dryer.

The invention is based on the object here of easily taking a dryer portion of a dryer to an assembly site and being able to complete it there easily.

This object is achieved according to the invention in that the method comprises the following method steps:
producing at least one left-hand side wall component, which comprises a left-hand side wall portion of the dryer;
producing at least one right-hand side wall component, which comprises a right-hand side wall portion of the dryer, wherein the at least one left-hand side wall component, the at least one right-hand side wall component or at least one further component comprises a base wall portion and/or a ceiling wall portion of the dryer and a conveying unit of a conveying device assembled from a plurality of parts to convey workpieces to be dried through the dryer in the assembled state of the dryer;
transporting the at least two components from a respective production site of the at least two components to a common assembly site of the dryer;
assembling the dryer portion at the assembly site from the at least two components.

The method according to the invention preferably has the features and/or advantages described above in conjunction with the kit according to the invention, the combination according to the invention and/or the dryer according to the invention.

It is provided in one configuration of the invention that at least one of the components is constructed from a plurality of component parts non-releasably connected to one another (or joined to form one piece) and from a plurality of component parts releasably connected to one another and from a plurality of component parts movably fixed to one another and in this way is prefabricated, before the component is transported to the assembly site.

Furthermore, the kit according to the invention, the combination according to the invention, the dryer according to the invention and/or the method according to the invention, may preferably have the features and/or advantages listed below.

A dryer portion of the dryer, in the assembled state, has a length, for example, of about 1 m to, for example, about 12 m.

The conveying unit may, for example, be a monorail conveyor, in particular an inverted monorail conveyor (IMC), a chain conveyor, in particular a double chain conveyor, or a roller conveyor.

The conveying unit is preferably a system made of a plurality of carrying roller units following one another in the conveying direction, which, in each case, have at least one carrying roller, the carrying roller units being arranged, in particular separately, on a respective base wall portion, advantageously recessed. A conveying unit of this type is, for example, a convection-integrated conveyor (C-IC).

It may be advantageous if the conveying units of the conveying device are integrated in the base wall portion.

In particular when the conveying units for conveying the workpieces to be dried through the dryer, in the assembled state of the dryer, are arranged recessed in the base wall portion of the dryer, the dryer may have a particularly small overall height.

The kit according to the invention preferably comprises a folding system for a dryer portion (a dryer tunnel module).

Further features and/or advantages of the invention are the subject of the following description and the graphical view of embodiments.

### BRIEF DESCRIPTION OF THE DRAWINGS

FIG. 1 shows a schematic sectional view of a first embodiment of a dryer with the viewing direction in a conveying direction of a conveying device of the dryer;

FIG. 2 shows a view corresponding to FIG. 1 of the first embodiment of the dryer in an incompletely assembled state of the dryer, in which no connecting elements are provided between individual components of the dryer;

FIG. 3 shows a schematic view of three components of a kit, from which the dryer portion of the first embodiment of the dryer is configured to be assembled;

FIG. 4 shows a schematic view of the three components of the kit from FIG. 3, a ceiling wall portion of a component being pivoted onto a side wall portion of the same component;

FIG. 5 shows a schematic view of the three components of the kit from FIG. 3, the ceiling wall portion of the one component being completely pivoted onto the side wall portion of the same component;

FIG. 6 shows a schematic view corresponding to FIG. 1 of a second embodiment of a dryer, which is configured to be assembled from four components of a kit;

FIG. 7 shows a view corresponding to FIG. 6 of the second embodiment of the dryer, the individual components of the kit for the dryer potion of the dryer not being connected by connecting elements;

FIG. 8 shows a view corresponding to FIG. 6 of the second embodiment of the dryer, a ceiling wall portion, which forms a component of the kit for a dryer portion of the dryer, having been removed from the remaining components;

FIG. 9 shows a view corresponding to FIG. 8 of the second embodiment of the dryer, the four components of the kit for the dryer portion of the dryer not being connected to one another;

FIG. 10 shows a view corresponding to FIG. 1 of a third embodiment of a dryer, which is producible from a kit with three components, one component comprising a side wall, which substantially extends over the entire height of the dryer in the assembled state of the dryer;

FIG. 11 shows a view corresponding to FIG. 10 of the third embodiment of the dryer, the individual components of the kit for the dryer portion of the dryer not being connected to one another by connecting elements;

FIG. 12 shows a view corresponding to FIG. 11 of the third embodiment of the dryer, a component, which comprises a side wall, having been removed from the remaining components;

FIG. 13 shows a view corresponding to FIG. 12 of the third embodiment of the dryer, all three components of the kit for the dryer portion of the dryer having been removed from one another and a ceiling wall portion, which, together with a left-hand side wall portion of the dryer forms a component of the kit, having been pivoted onto the left-hand side wall portion;

FIG. 14 shows a schematic view corresponding to FIG. 13 of the third embodiment of the dryer, the ceiling wall portion being completely pivoted onto the left-hand side wall portion;

FIG. 15 shows a schematic view corresponding to FIG. 1 of a fourth embodiment of a dryer, which is configured to be assembled from two components of a kit;

FIG. 16 shows a schematic view corresponding to FIG. 15 of the fourth embodiment of the dryer, the two components of the kit for the dryer portion of the dryer not being connected to one another by connecting elements;

FIG. 17 shows a schematic view corresponding to FIG. 16 of the fourth embodiment of the dryer, the two components of the kit for the dryer portion of the dryer being removed from one another;

FIG. 18 shows a schematic view corresponding to FIG. 17 of the fourth embodiment of the dryer, a base wall portion being connected to a right-hand side wall portion and pivoted onto the latter and a ceiling wall portion being connected to a left-hand side wall portion and being pivoted onto the latter;

FIG. 19 shows a schematic view corresponding to FIG. 18 of the fourth embodiment of the dryer, the base wall portion being completely pivoted onto the right-hand side wall portion and the ceiling wall portion being completely pivoted onto the left-hand side wall portion;

FIG. 20 shows a schematic view corresponding to FIG. 1 of a fifth embodiment of the dryer, which is configured to be assembled from four components of a kit for a dryer portion of the dryer;

FIG. 21 shows a schematic view corresponding to FIG. 20 of the fifth embodiment of the dryer, four components of the kit for the dryer portion of the dryer not being connected to one another by means of connecting elements;

FIG. 22 shows a schematic view corresponding to FIG. 21 of the fifth embodiment of the dryer, a ceiling wall portion, which forms a component of the kit, having been removed from the remaining components;

FIG. 23 shows a schematic view corresponding to FIG. 22 of the fifth embodiment of the dryer, the four components of the kit for the dryer portion of the dryer having been removed from one another; and

FIG. 24 shows a schematic view corresponding to FIG. 1 of a sixth embodiment of a dryer, which does not have an air feed in a base wall portion of the dryer.

The same or functionally equivalent elements are provided with the same reference numerals in all the figures.

### DETAILED DESCRIPTION OF THE DRAWINGS

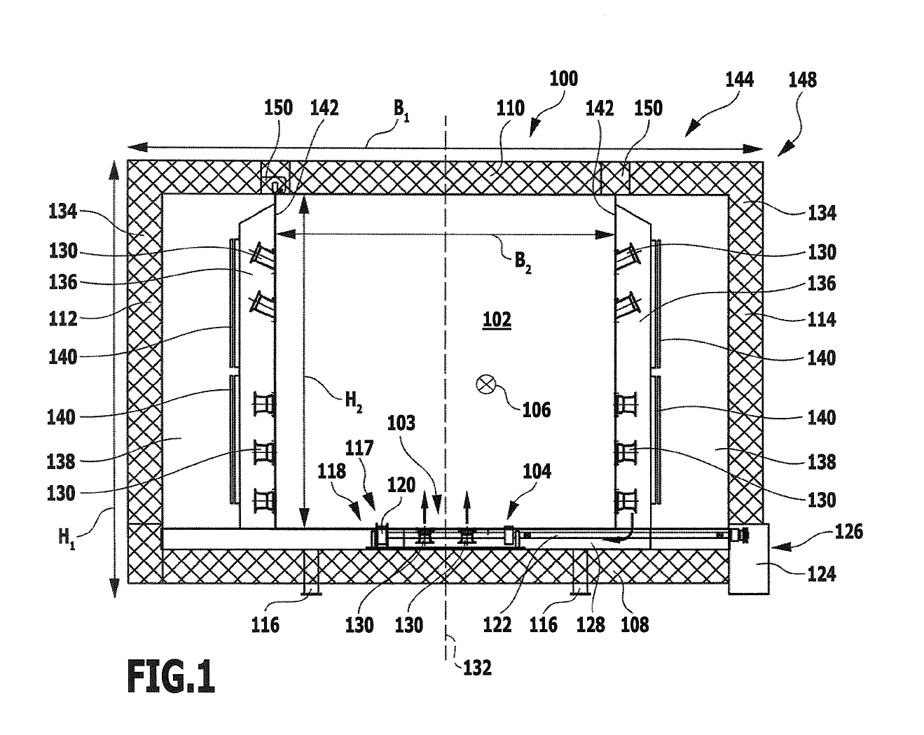

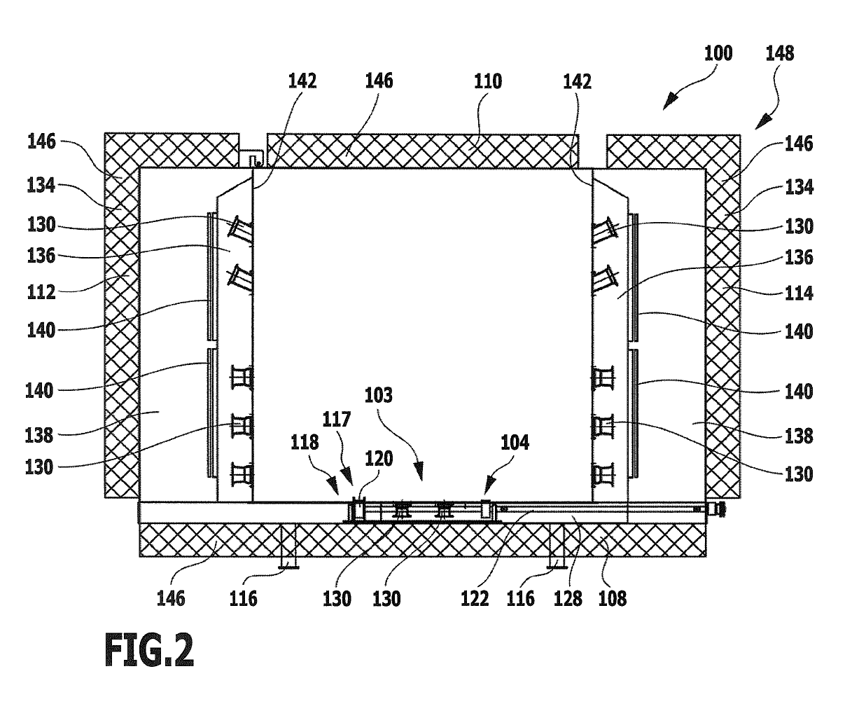

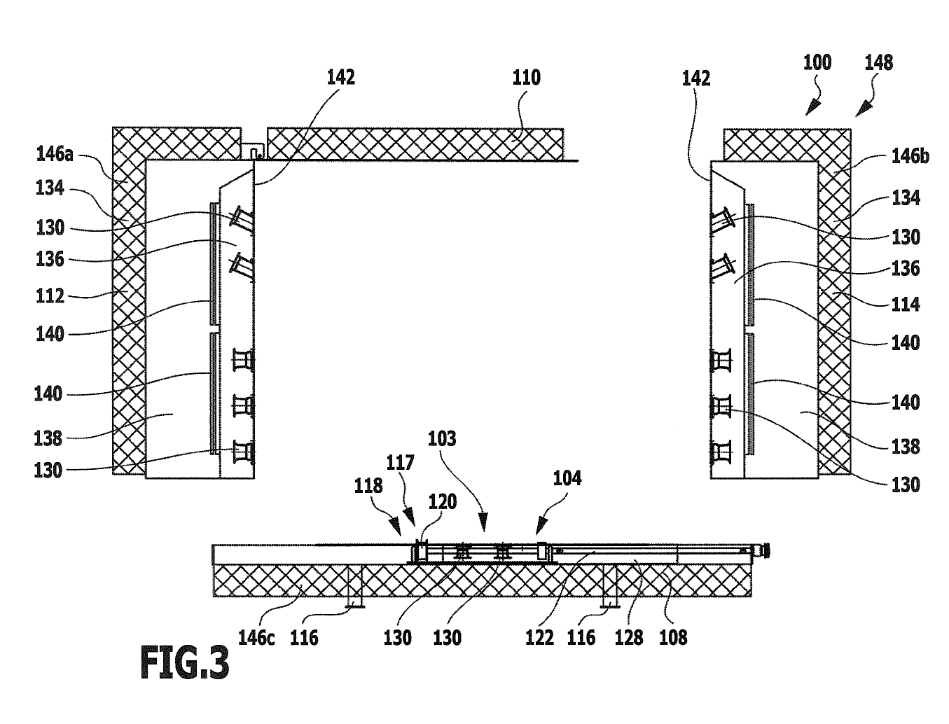

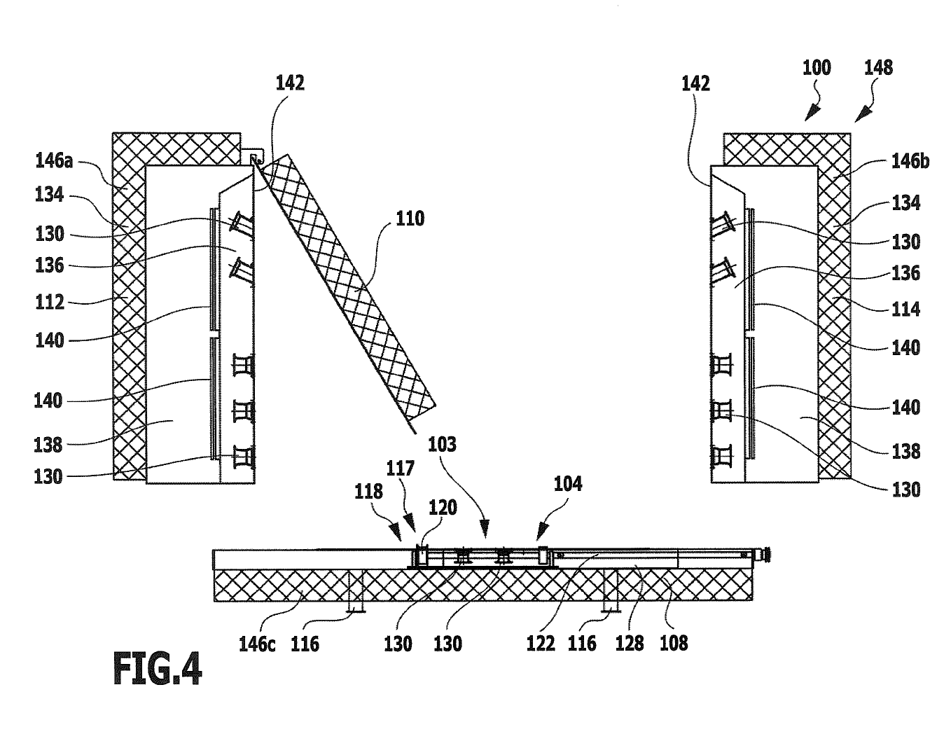

A first embodiment shown in FIGS. 1 to 5 of a dryer designated “100” as a whole is used, for example, to dry and/or cure surface-treated workpieces (not shown), in particular painted bodies and/or body parts.

As, in particular, can be inferred from FIG. 1, the dryer 100, for this purpose, comprises a usable dryer space 102, in which the workpieces to be dried can be arranged. In particular, the workpieces to be dried can be conveyed by means of a conveying device 103, which comprises a plurality of conveying units 104, in a conveying direction 106 through the usable dryer space 102.

The dryer 100 is substantially cuboidal and comprises a base wall portion 108, a ceiling wall portion 110, a left-hand side wall portion 112 and a right-hand side wall portion 114.

The base wall portion 108 in this case limits the usable dryer space 102 together with the ceiling wall portion 110 in the vertical direction. In the horizontal direction and perpendicular to the conveying direction 106, the usable dryer space 102 is limited by the left-hand side wall portion 112 and the right-hand side wall portion 114.

The base wall portion 108 comprises support feet 116 to support the dryer 100 on a floor space (not shown).

The base wall portion 108, in the assembled state of the dryer 100, extends over the entire width B₁ of the dryer 100 and comprises at least one conveying unit 104 of the conveying device 103 for conveying the workpieces to be dried through the usable dryer space 102.

The conveying units 104 are arranged following one another in the conveying direction 106 and in each case comprise at least one carrying roller unit 117, which comprises at least one carrying roller receiver 118 to receive carrying rollers 120, on which a workpiece carrier can be supported to receive workpieces.

The carrying rollers 120 of the conveying device 103 are driven by means of a shaft 122, which is in turn made to rotate by a motor 124.

The motor 124, in this case, together with the shaft 122, is a component part of a drive device 126 to automatically drive the workpieces to be conveyed by means of the conveying device 103.

Basically, a separate drive device 126 does not have to be provided for each carrying roller 120. Rather, a plurality of carrying rollers 120 can be driven using only one drive device 126 by means of a chain or an angular gear. In particular, only one drive device 126 may be provided per component 146 (still to be described) and/or dryer portion 144.

Furthermore, the base wall portion 108 comprises an air shaft 128, by means of which air is feedable to a plurality of air feeds 130, which are configured, for example, as nozzles.

This air is then feedable through the air feeds 130 to the usable dryer space 102.

The left-hand side wall portion 112 and the right-hand side wall portion 114 are arranged on the base wall portion 108.

The left-hand side wall portion 112 and the right-hand side wall portion 114 are, in this case, configured substantially mirror-symmetrically to one another with respect to a vertical longitudinal centre plane 132 of the dryer 100 and in each case comprise an outer wall 134, which simultaneously forms an outer wall 134 of the dryer 104 and is preferably thermally insulating.

On the respective side of the left-hand side wall portion 112 and of the right-hand side wall portion 114 facing the usable dryer space 102, the left-hand side wall portion 112 and the right-hand side wall portion 114 are provided with filter boxes 136, which extend approximately over a total height H₂ of the usable dryer space 102.

A supply channel 138, by means of which the air feeds 130 can be supplied with air, is formed by means of the filter boxes 136 and the outer wall 134 in the left-hand side wall portion 112 and the right-hand side wall portion 114 in each case.

The filter boxes 136 comprise a plurality of filters 140, through which air from the supply channels 138 can arrive in the filter boxes 136. The fed air is freed of impurities by means of the filter 140.

An inner wall 142 of the left-hand side wall portion 112 delimiting the filter boxes 136 toward the usable dryer space 102 and a corresponding inner wall 142 of the right-hand side wall portion 114 are therefore provided with a plurality of, for example, in each case five, air feeds 130, so air is feedable to the usable dryer space 102 both by means of the base wall portion 108 and also by means of the left-hand side wall portion 112 and the right-hand side wall portion 114.

The ceiling wall portion 110 extends between the right-hand side wall portion 114 and the left-hand side wall portion 112 over the entire width B₂ of the usable dryer space 102 and is used only to upwardly seal and thermally insulate the usable dryer space 102. Air feeds are not provided in the ceiling wall portion 110.

It cannot be seen from the figures that the dryer 100 can be formed from a plurality of dryer portions 144 following one another in the conveying direction 106.

Each dryer portion 144 is preferably configured to be assembled here from few prefabricated components 146 of a kit 148 for a dryer portion 144 of the dryer 100.

The above-described first embodiment of the dryer 100 functions as follows:

Air, which is feedable by means of the air feeds 130 in the left-hand side wall portion 112 and the right-hand side wall portion 114 to the usable dryer space 102, is fed through the supply channels 138 to the filter boxes 136 in the left-hand side wall portion 112 and in the right-hand side wall portion 114. Furthermore, because of the fluid connection between the filter box 136 of the right-hand side wall portion 114 and the air shaft 128 in the base wall portion 108, a supply of the air feeds 130 in the base wall portion 108 with air is ensured, so air is also feedable by means of the base wall portion 108 to the usable dryer space 102.

A workpiece, for example a vehicle body, conveyed through the usable dryer space 102 in the conveying direction 106 by means of the conveying device 103, has the fed air applied and is thereby dried.

The workpiece can be conveyed automatically here by means of the drive device 126.

As can be inferred from FIGS. 1 to 5, the first embodiment of the dryer 100, but at least one dryer portion 144 of the dryer 100, can be assembled by means of a kit 148 from three components 146.

A first component 146a is a left-hand side wall component 146a and simultaneously a ceiling wall component 146a, as it comprises the left-hand side wall portion 112 and the ceiling wall portion 110, the ceiling wall portion 110 being pivotably arranged on the left-hand side wall portion 112.

A second component 146b is a right-hand side wall component 146b and comprises the right-hand side wall portion 114.

A third component 146c is a base wall component 146c and comprises the base wall portion 108.

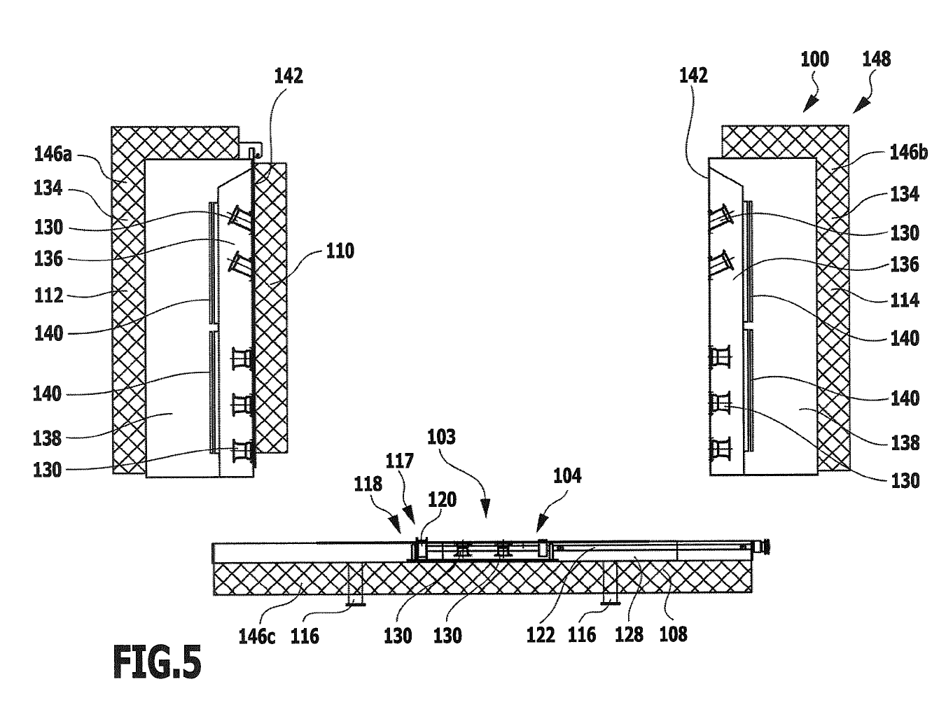

As can be inferred, in particular from FIG. 5, an extension of the first component 146a for transportation of the kit 148 is minimised in the state of the ceiling wall portion 110, in which it is completely pivoted onto the left-hand side wall portion 112.

The three components 146 of the kit 148 can be assembled at an assembly site of the dryer portion 144 of the dryer 100, only the left-hand side wall portion 112 and the right-hand side wall portion 114 initially having to be placed on the base wall portion 108. The ceiling wall portion 110 is then pivoted into a horizontal position. Finally, connecting elements 150 also have to be arranged between the components 146 in order to produce the mechanical stability of the dryer portion 144 of the dryer 100.

The connecting points between the components 146 can be welded tight in order to avoid air undesirably escaping from the usable dryer space 102.

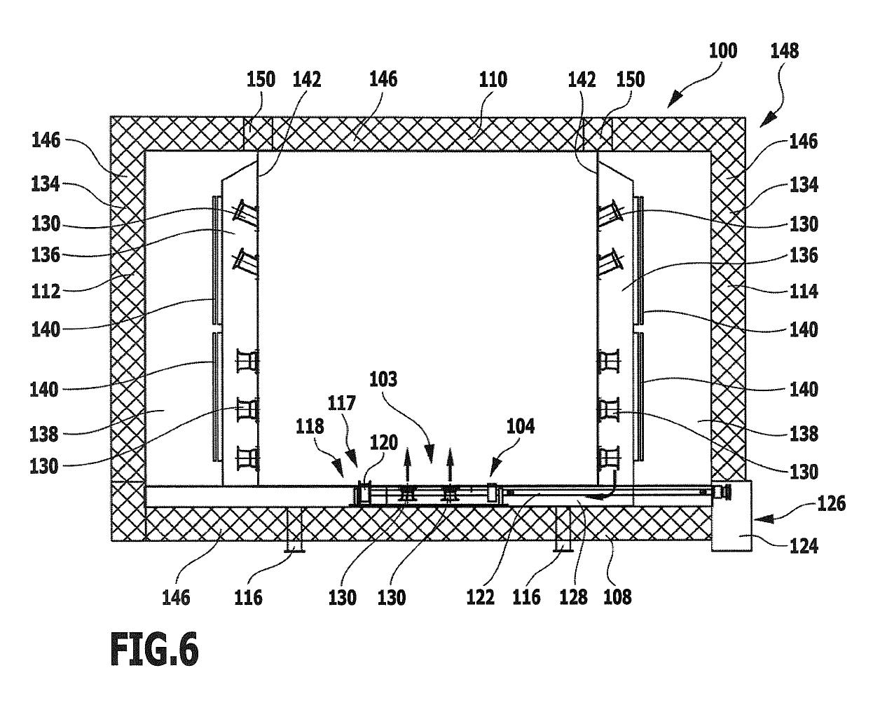

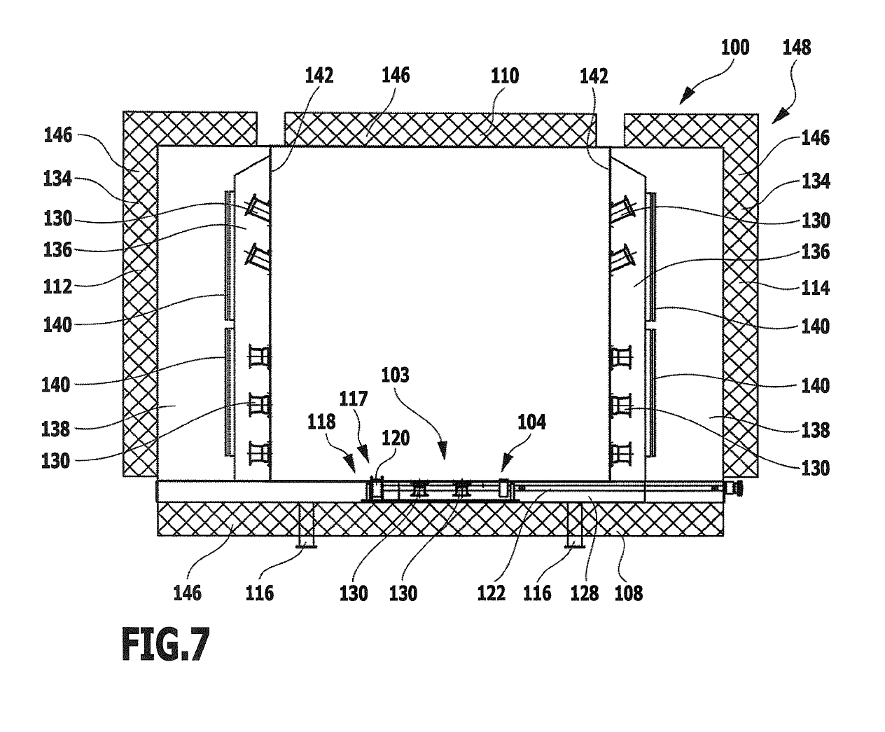

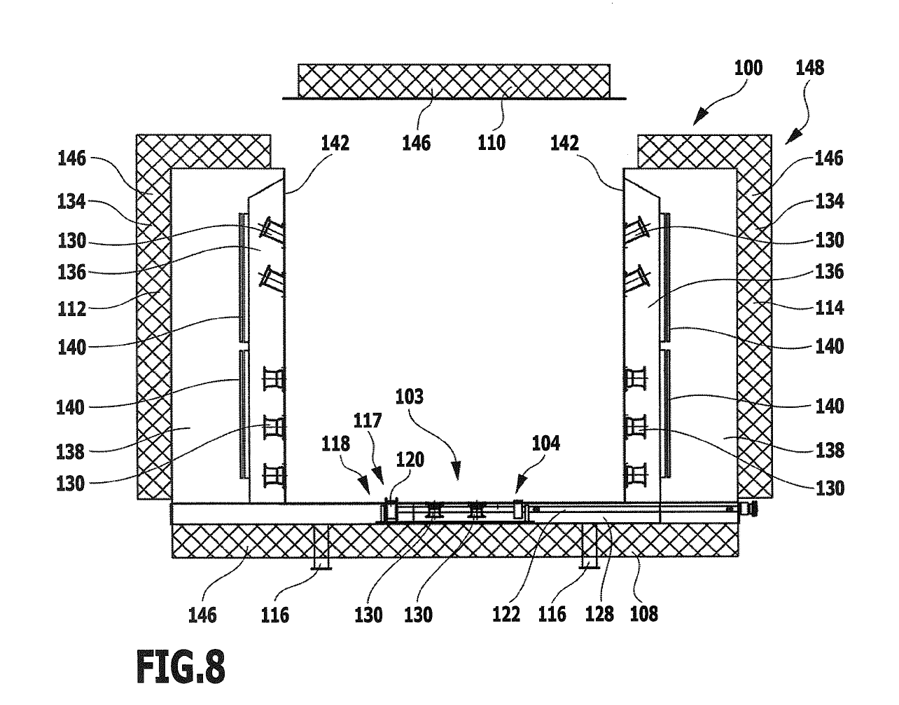

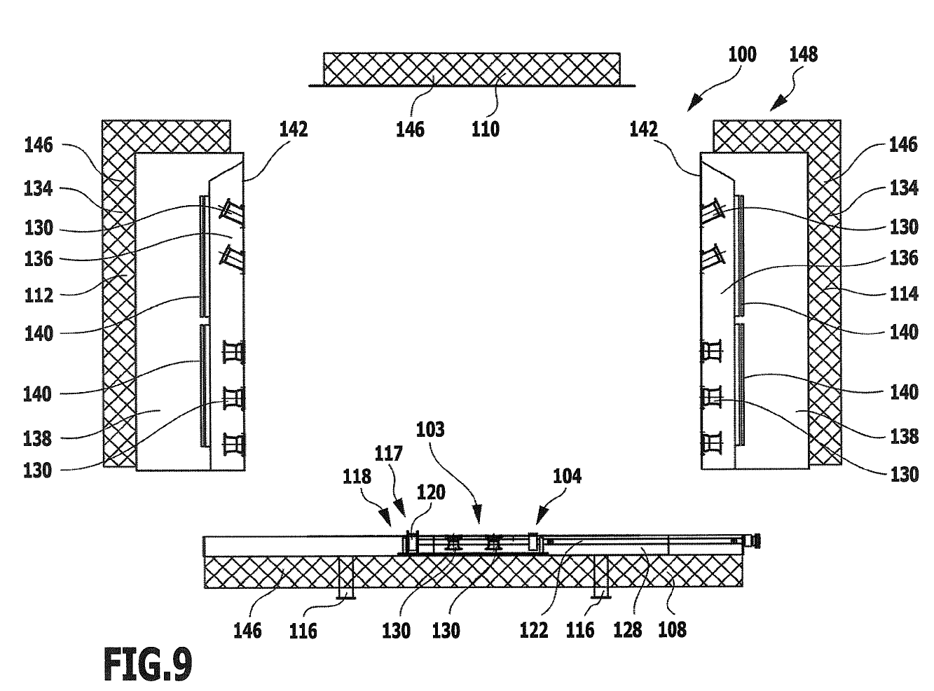

A second embodiment of a dryer 100 shown in FIGS. 6 to 9 differs from the first embodiment shown in FIGS. 1 to 5 only in that four components 146 are provided to produce the dryer portion 144 of the dryer 100. The ceiling wall portion 110 is not connected here to the left-hand side wall portion 112. Rather, a separate production and a separate transportation of the ceiling wall portion 110 take place.

Otherwise, the second embodiment shown in FIGS. 6 to 9 coincides with respect to structure and function with the first embodiment shown in FIGS. 1 to 5, so to this extent reference is made to the above description thereof.

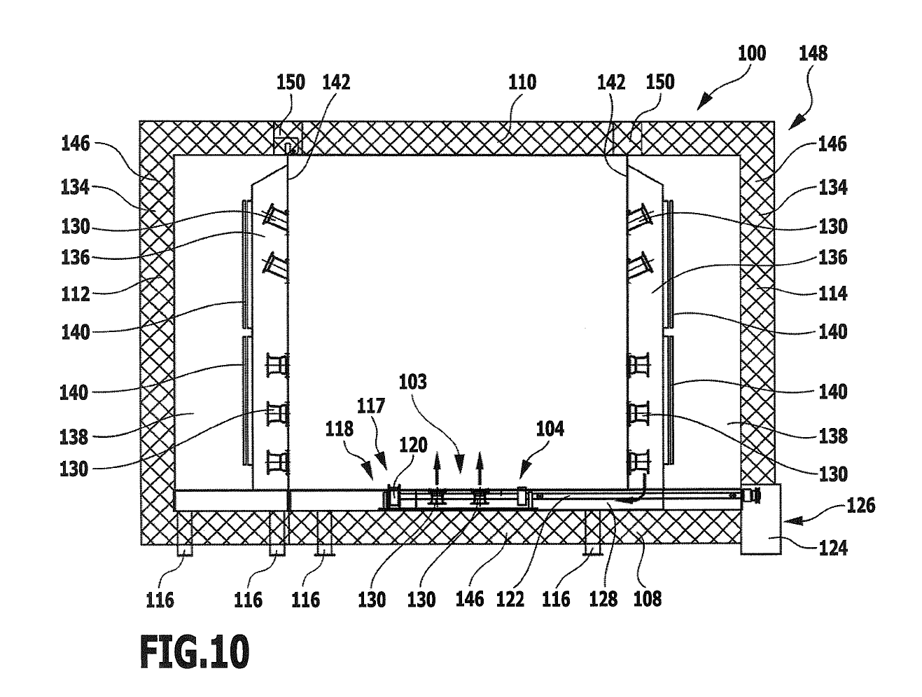

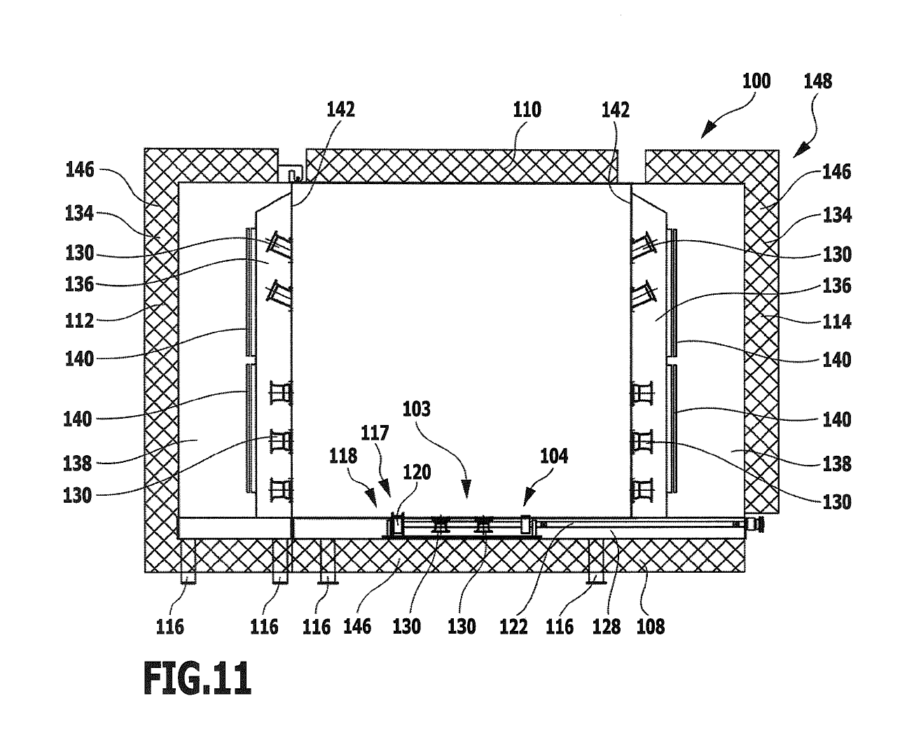

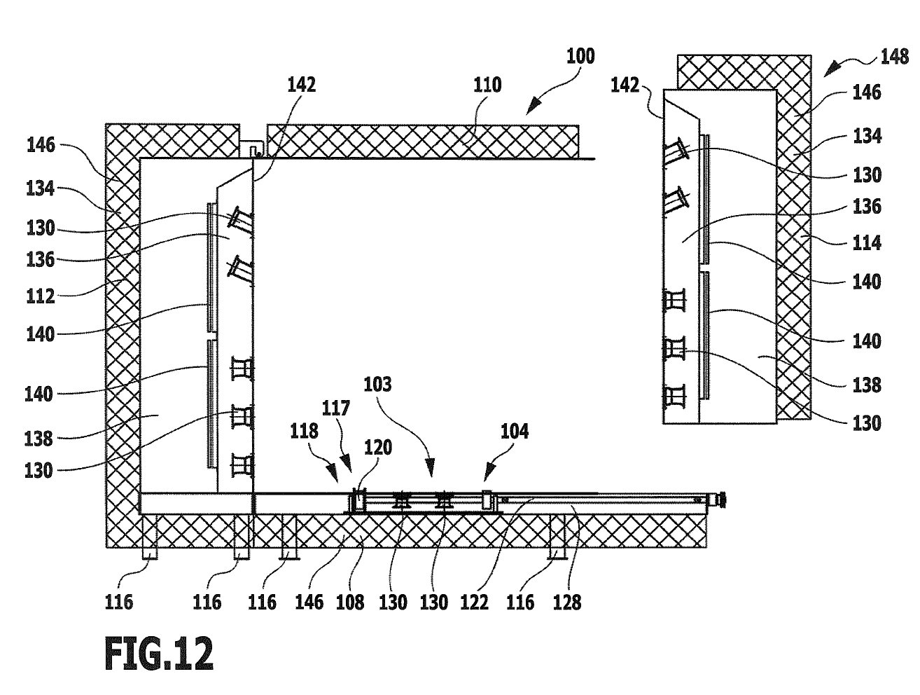

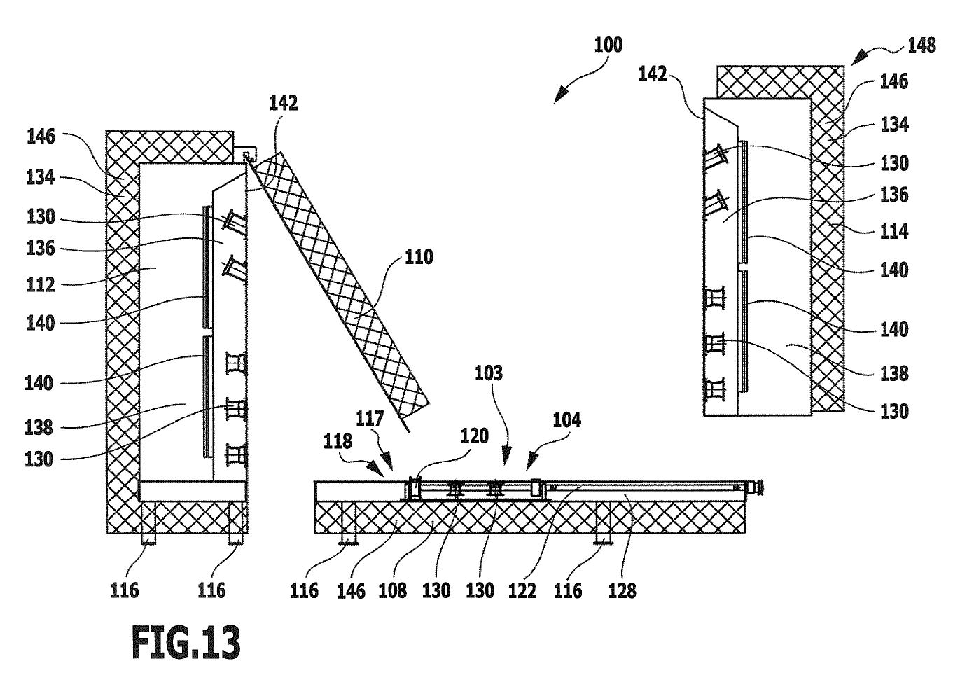

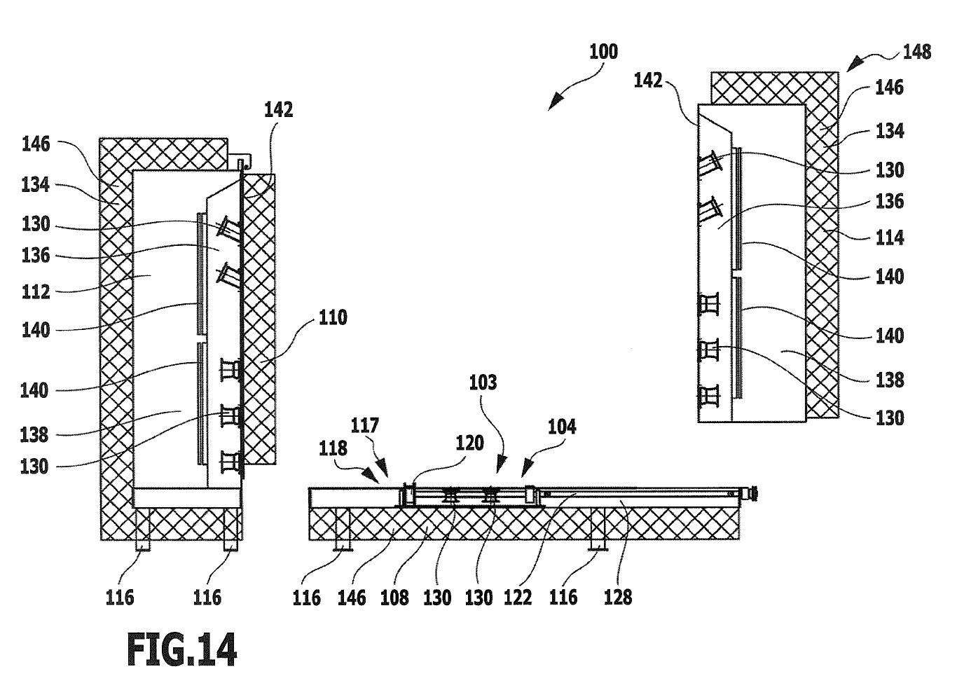

A third embodiment of a dryer 100 shown in FIGS. 10 to 14 differs from the first embodiment shown in FIGS. 1 to 5 in particular in that the base wall portion 108 does not extend over the entire width B₁ of the dryer 100. The left-hand side wall portion 112 is not arranged on the base wall portion 108, but extends over the entire height H₁ of the dryer in the assembled state of the dryer 100. The base wall portion 108 is therefore placed, for connection of the components 146 of the kit 148, laterally onto the left-hand side wall portion 112 and connected thereto.

Otherwise, the third embodiment shown in FIGS. 10 to 14 coincides with respect to structure and function to the first embodiment shown in FIGS. 1 to 5, so to this extent reference is made to the above description thereof.

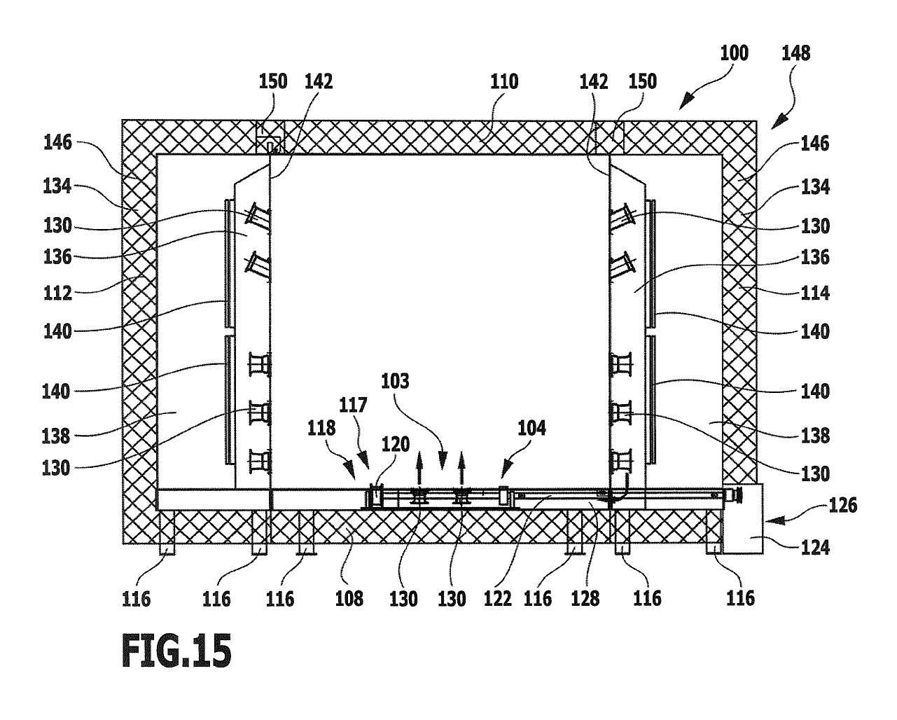

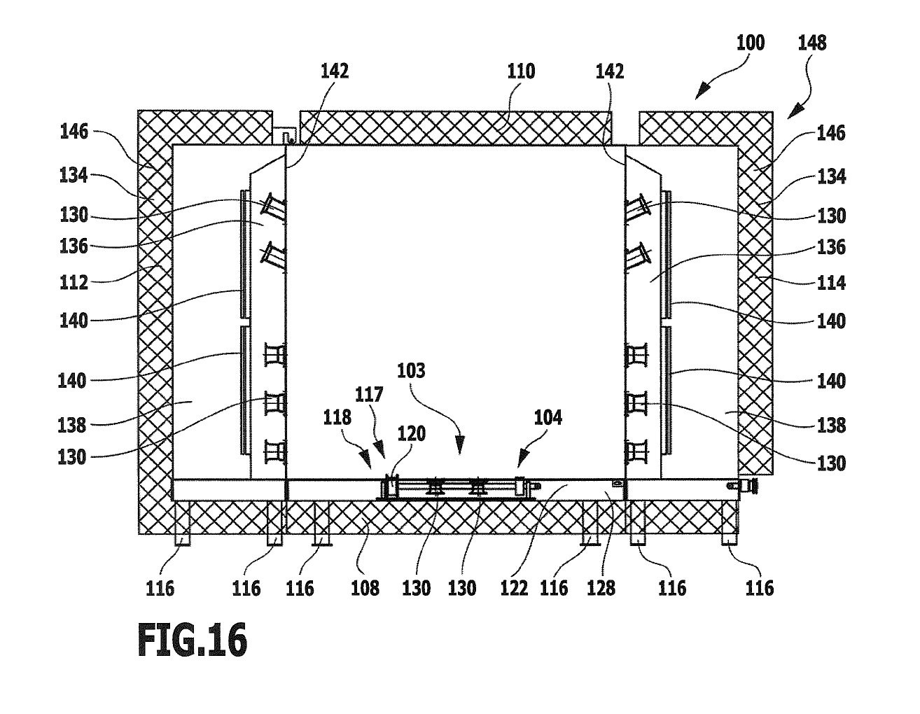

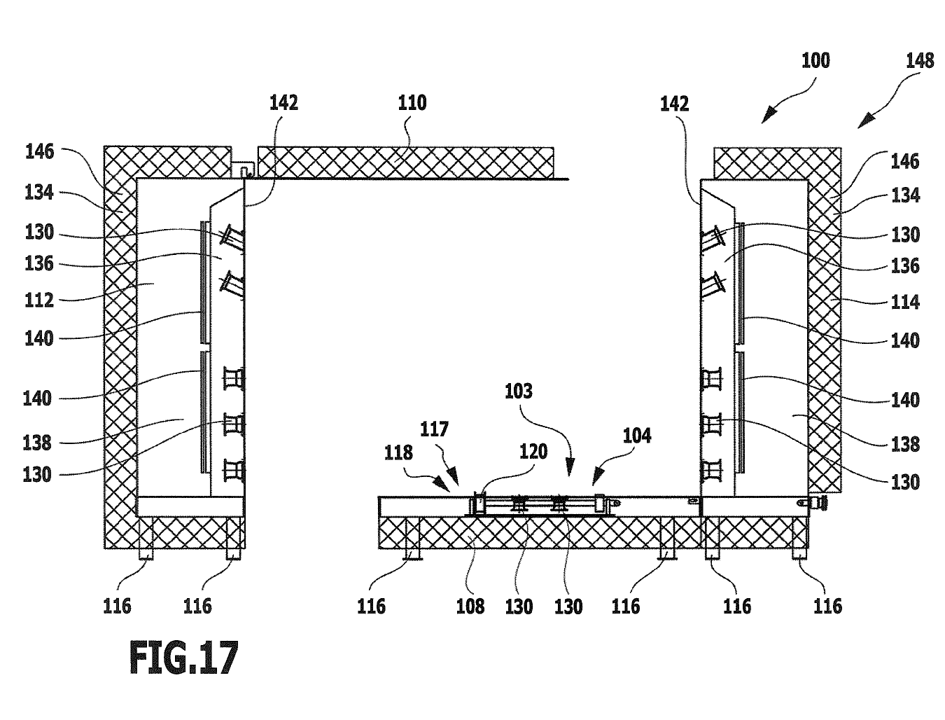

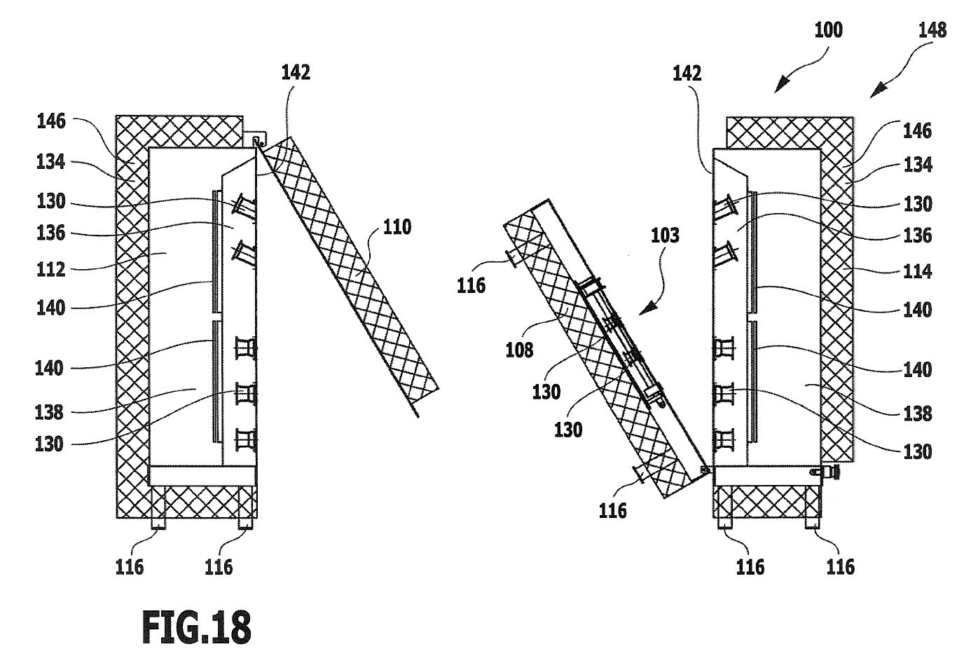

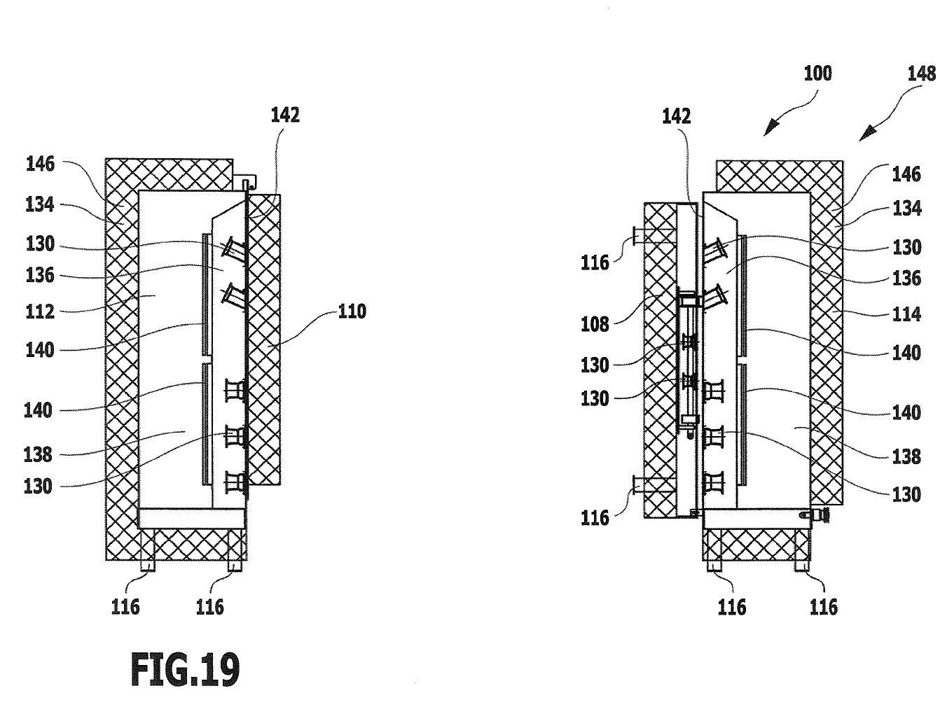

A fourth embodiment of a dryer 100 shown in FIGS. 15 to 19 differs from the third embodiment shown in FIGS. 10 to 14 in that not only the left-hand side wall portion 112 extends over the entire height H₁ of the dryer 100, but also the right-hand side wall portion 114.

Both the base wall portion 108 and the ceiling wall portion 110 therefore extend only over the width B₂ of the usable dryer space 102 in the assembled state of the dryer 100.

It is furthermore provided in the fourth embodiment of the dryer 100 that the base wall portion 108 is pivotably arranged on the right-hand side wall portion 114.

The ceiling wall portion 110 can therefore be folded onto the left-hand side wall portion 112 for transportation of the two components 146 of the kit 148 to produce a dryer portion 144 of the fourth embodiment of the dryer 100. Furthermore, the base wall portion 108 can be folded onto the right-hand side wall portion 114.

Otherwise, the fourth embodiment shown in FIGS. 15 to 19 coincides with respect to structure and function to the third embodiment shown in FIGS. 10 to 14, so to this extent reference is made to the above description thereof.

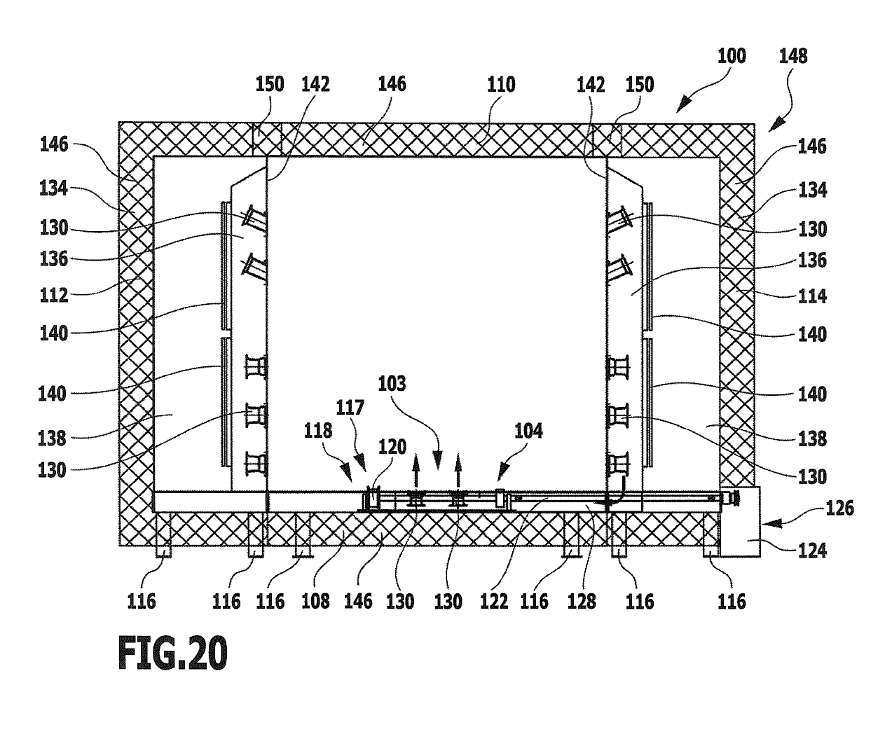

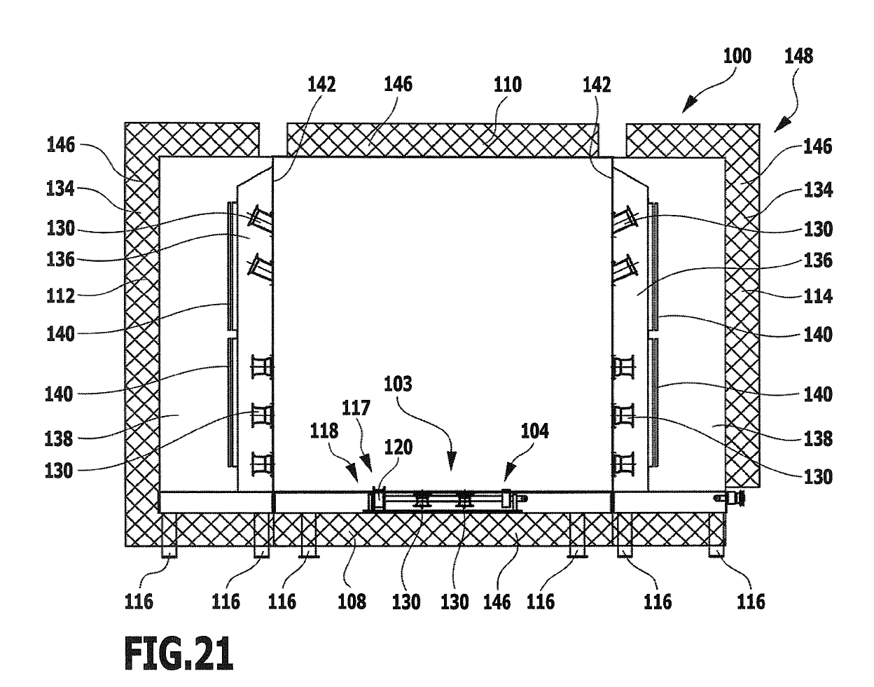

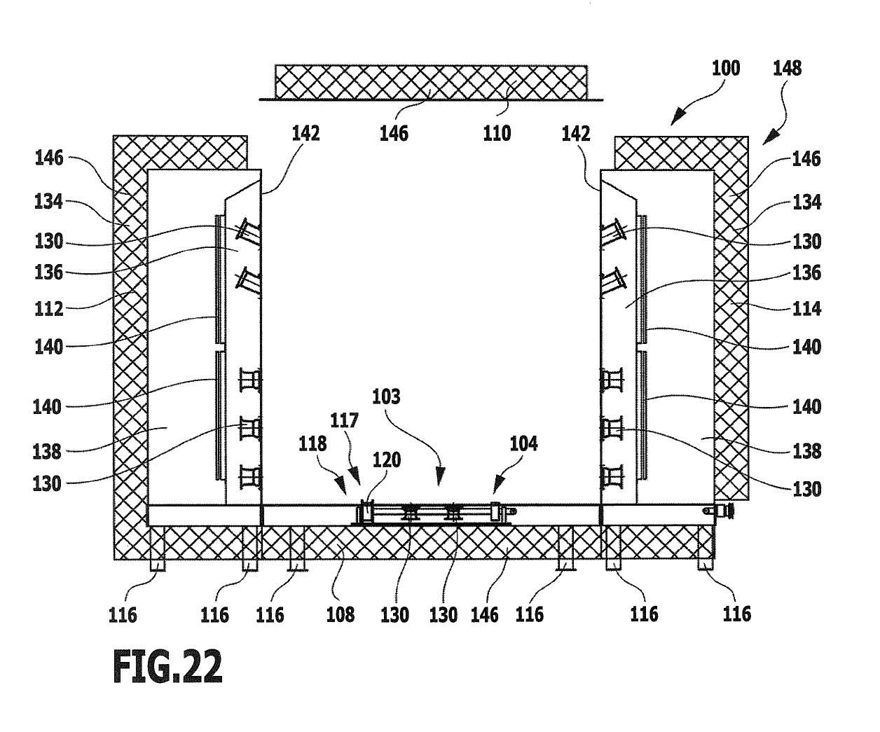

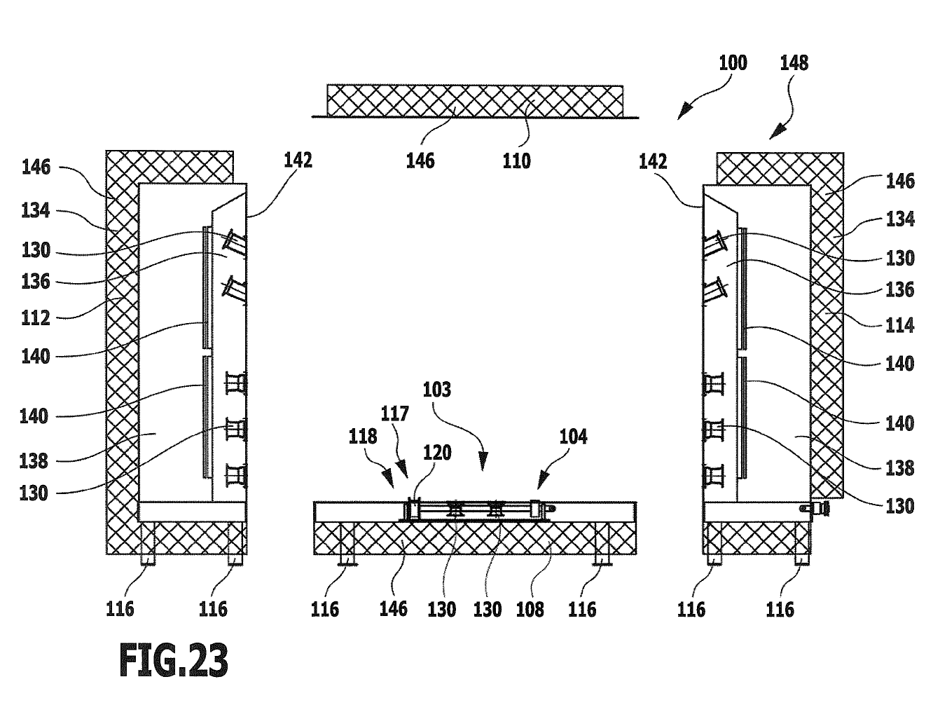

A fifth embodiment of a dryer 100 shown in FIGS. 20 to 23 differs from the second embodiment shown in FIGS. 6 to 9 in that the left-hand side wall portion 112 and the right-hand side wall portion 114 extend over the entire height H₁ of the dryer 100, so two separate components 146 are provided, namely a ceiling wall portion 110 and a base wall portion 108, which, in the assembled state of the dryer 100, extend only over the width B₂ of the usable dryer space 102.

In the fifth embodiment of the dryer 100, four components of the kit 148 are therefore provided to produce a dryer portion 144 of the dryer 100.

Otherwise, the fifth embodiment shown in FIGS. 20 to 23 coincides with respect to structure and function to the second embodiment shown in FIGS. 6 to 9, so to this extent reference is made to the above description thereof.

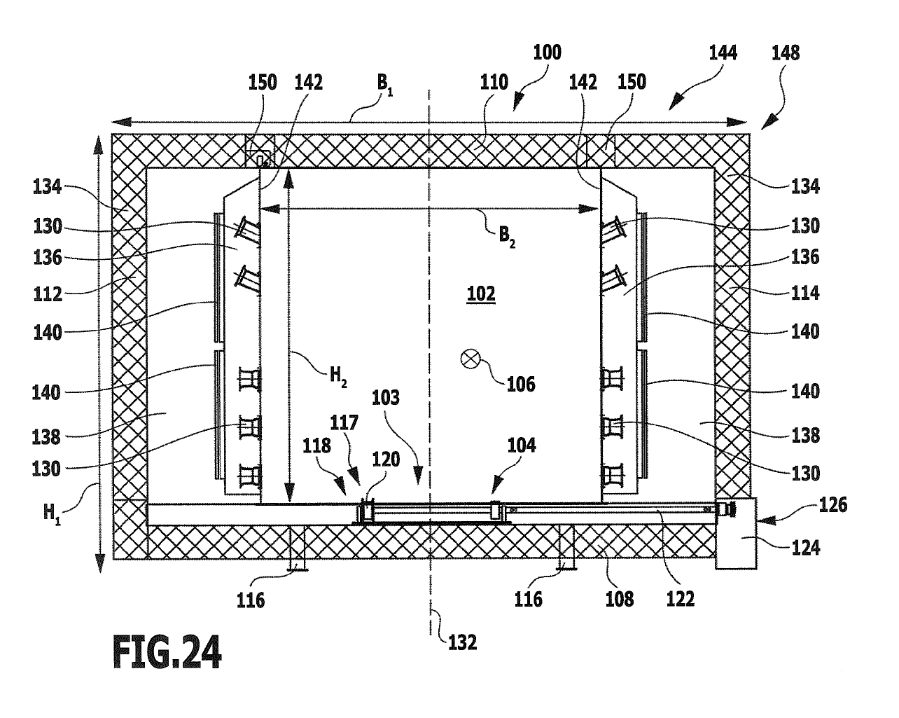

A sixth embodiment shown in FIG. 24 of a dryer 100 differs from the first embodiment shown in FIGS. 1 to 5 substantially in that no air feeds are provided in the base wall portion 108. Consequently, the filter boxes 136 in the left-hand side wall portion 112 and in the right-hand side wall portion 114 do not necessarily extend to an upper side of the base wall portion 108, as no fluid connection is necessary between an air shaft in the base wall portion 108 and the filter box 136.

The above-described embodiments one to five are all described with air feeds 130 integrated into the base wall portion 108. However, in accordance with the configuration of the sixth embodiment of the dryer 100, each of the other embodiments one to five can also, however, be configured without a feed of air through the base wall portion 108.

Since the embodiments shown of the dryer 100 can be constructed from dryer portions 144, which are in turn configured to be assembled from components 146 of a kit 148, a particularly easy transportation of prefabricated parts of the dryer 100 to an assembly site of the dryer 100 is possible. Furthermore, the number of component parts required to assemble the dryer 100, and therefore the assembly time required to assemble the dryer 100, is reduced by the number of components 146, in particular by the use of a preassembled conveying unit 104 of a conveying device 103 in a base wall portion 108 of a component 146.

That which is claimed:

1. A kit for a dryer portion of a dryer, wherein the kit comprises at least two components, wherein at least one left-hand side wall component comprises a left-hand side wall portion of the dryer, wherein at least one right-hand side wall component comprises a right-hand side wall portion of the dryer and wherein at least one component comprises at least one of a base wall portion and a ceiling wall portion of the dryer and a conveying unit of a conveying device for conveying workpieces to be dried through the dryer in the assembled state of the dryer, the dryer portion of the dryer being configured to be assembled at an assembly site from the at least two components of the kit.

2. The kit according to claim 1, wherein the base wall portion comprises at least one air feed, by means of which air is feedable to a usable dryer space of the dryer in an assembled state of the dryer.

3. The kit according to claim 1, wherein at least one component of the kit comprises a side wall portion and a base wall portion.

4. The kit according to claim 1, wherein at least one component of the kit is a prefabricated component, which comprises a side wall portion and a ceiling wall portion of the dryer.

5. The kit according to claim 1, wherein at least one component comprises a base wall portion, which, in an assembled state of the dryer, extends at least over the entire width of a usable dryer space of the dryer.

6. The kit according to claim 1, wherein at least one component comprises a base wall portion, which, in an assembled state of the dryer, extends at least approximately over the entire width of the dryer.

7. The kit according to claim 1, wherein the conveying unit of the conveying device to convey workpieces to be dried through the dryer comprises a plurality of carrying roller units, which follow one another in a conveying direction of the conveying device and in each case have at least one carrying roller receiver to receive a carrying roller, on which workpiece carriers, on which the workpieces to be dried are configured to be arranged, are placeable in the assembled state of the dryer.

8. The kit according to claim 1, wherein the kit comprises a drive device for driving the conveying device, the drive device being arranged on at least one of a side wall portion and the base wall portion, or wherein at least one component comprises a side wall portion, which extends, in an assembled state of the dryer, at least over the entire height of a usable dryer space of the dryer.

9. The kit according to claim 1, wherein at least one component comprises a side wall portion, which, in an assembled state of the dryer, extends at least approximately over the entire height of the dryer.

10. The kit according to claim 1, wherein the conveying unit of the conveying device is preassembled on the at least one component.

11. A combination of a kit according to claim 1 and a receiving device for receiving the at least two components of the kit during transportation of the kit from at least one production site of the at least two components to the assembly site of the dryer.

12. A dryer, which is producible using at least one kit for a dryer portion of a dryer, wherein the kit comprises at least two components, wherein at least one left-hand side wall component comprises a left-hand side wall portion of the dryer, wherein at least one right-hand side wall component comprises a right-hand side wall portion of the dryer and wherein at least one component comprises at least one of a base wall portion and a ceiling wall portion of the dryer and a conveying unit of a conveying device for conveying workpieces to be dried through the dryer in the assembled state of the dryer, the dryer portion of the dryer being configured to be assembled at an assembly site from the at least two components of the kit.

13. The dryer according to claim 12, wherein the dryer comprises a plurality of base wall portions, which are arranged following one another in a conveying direction of the conveying device and in each case comprise at least one air feed, the base wall portions, to supply the air feeds with air, alternately having a fluid connection to at least one supply channel in at least one right-hand side wall portion and to at least one supply channel in at least one left-hand side wall portion.

14. A method for producing a dryer portion of a dryer comprising:
producing at least one left-hand side wall component, which comprises a left-hand side wall portion of the dryer;
producing at least one right-hand side wall component, which comprises a right-hand side wall portion of the dryer, wherein the at least one left-hand side wall component, the at least one right-hand side wall component or at least one further component comprises at least one of a base wall portion and a ceiling wall portion of the dryer and a conveying unit of a conveying device assembled from a plurality of parts to convey workpieces to be dried through the dryer in the assembled state of the dryer;
transporting the at least two components from a respective production site of the at least two components to a common assembly site of the dryer;
assembling the dryer portion at the assembly site from the at least two components.

15. The method according to claim 14, in which at least one of the components is constructed from a plurality of component parts non-releasably connected to one another and from a plurality of component parts releasably connected to one another and from a plurality of component parts movably fixed to one another and in this way is prefabricated before the component is transported to the assembly site.
